(19) United States
(12) Patent Application Publication
(10) Pub. No.: US 2026/0262127 A1
(43) Pub. Date: Sep. 3, 2026

(54) Radio Network Node, Network Node, and Methods Performed Therein

(71) Applicant: Telefonaktiebolaget LM Ericsson (publ), Stockholm (SE)

(72) Inventors: Mohammed Yazid Lyazidi, London (GB); Qian Chen, Mölndal (SE); Emre Yavuz, Stockholm (SE)

(21) Appl. No.: 19/163,595

(22) PCT Filed: Apr. 5, 2024
(86) PCT No.: PCT/SE2024/050318

§ 371 Date: Sep. 9, 2025

Related U.S. Application Data
(60) Provisional application No. 63/494,242, filed on Apr. 5, 2023.

(51) Int. Cl. H04W 76/27; H04W 72/23

(52) U.S. Cl. CPC H04W 76/27; H04W 72/23

(57) ABSTRACT

Embodiments herein relate to, for example, a method performed by a network node (16) for handling communication of a UE (10) in a communication network (1). The network node (16) receives from a radio network node (120), a message with an indication indicating that the UE has accessed the communication network for handling one or more SDTs.

### TECHNICAL FIELD

Embodiments herein relate to a network node, a radio network node, and methods performed therein regarding wireless communication. Furthermore, a computer program product and a computer readable storage medium are also provided herein. In particular, embodiments herein relate to handling communication of user equipments (UE) in a communication network.

### BACKGROUND

In a typical communication network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate e.g. enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases, such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an architecture comprising radio network nodes connected directly to one or more core networks.

With the emerging 5G technologies such as NR, the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions. NR is connected to the 5G Core Network (5GC) which comprises a number of Network Functions (NF) such as Session Management Function (SMF), Access Management Function (AMF), Authentication Service Function (AUSF), Policy Control Function (PCF), Unified Data Manager (UDM), Network Repository Function (NRF), Network Exposure Function (NEF), just to mention some. In the 5GC, NFs can discover other NFs by using a discovery service provided by the NRF.

In Release (Rel)-17, Small Data Transmission (SDT) was defined by 3GPP as a procedure allowing data and/or signalling transmission from the UE to the network while the UE remains in an RRC_INACTIVE state, i.e., without transitioning to an RRC_CONNECTED state. SDT is enabled on a radio bearer basis and is initiated by the UE, mobile originate-SDT (MO-SDT) only if less than a configured amount of UL data awaits transmission across all radio bearers for which SDT is enabled, the DL reference signal received power (RSRP) is above a configured threshold, and a valid SDT resource is available as specified in clause 5.27.1 of TS 38.321.

In Release-18, Mobile terminated-SDT (MT-SDT) is being specified, which is a procedure for initial DL data reception and subsequent UL/DL data transmissions for the UE in RRC_INACTIVE state. In MT-SDT session, the UE is restricted to RRC_INACTIVE state during the SDT transmission when it receives an MT-SDT indication in the RAN paging message, following a decision of the serving gNB to use MT-SDT paging.

On the other hand, in Release 18, the reduced capability (RedCap) study “FS_REDCAP_Ph2” targeting support of UE in RRC_INACTIVE state with long extended discontinuous reception (eDRX)>10.24s was agreed by SA2 and the specification work will start in RAN3 #119bis-e meeting. As part of the study conclusion and as captured in the SA2 TS 23.502 spec, the NG-RAN sends, based on implementation, a request to 5G core network (5GCN) for MT data and signalling handling within the CN when the UE is unreachable due to long extended DRX>10.24 sec in RRC inactive. The 5GCN then starts buffering the data and sends an N2 confirmation to NG-RAN so that the NG-RAN releases the UE to RRC_INACTIVE state. When the UE resumes in the network and is moved by the serving gNB to RRC_CONNECTED state, the 5GCN (UPF) buffering the data must be notified of this in order to deliver any available pending DL data to the UE. This is specified in the UE Triggered Connection Resume in RRC Inactive procedure defined in TS 23.502 section 4.8.2.2 below:

FIG. 1 or FIG. 4.8.2.2-1: Connection Resume in RRC Inactive

4.8.2.2 UE Triggered Connection Resume in RRC Inactive procedure
The Connection Resume procedure is used by the UE to perform RRC Inactive to RRC
Connected state transition. Triggers for the UE to initiate this procedure are defined in
clause 5.3.3.2.5 of TS 23.501 [2].

Another agreement was to support Network Triggered Connection Resume for UE in RRC Inactive with CN based MT communication handling. When there is DL MT data coming from the CN, the NG-RAN performs RAN paging towards the UE based on an N2 message from the AMF in order to trigger the UE triggered Connection Resume procedure. This is specified in TS 23.502 section 4.8.2.2b:

FIG. 2 or FIG. 4.8.2.2b-1: Network Triggered Connection Resume
for UE in RRC Inactive with CN based MT communication handling

4.8.2.2b Network Triggered Connection Resume in RRC Inactive with
CN based MT communication handling
When the UE is in connected mode (CM)-CONNECTED with RRC_INACTIVE state with CN based mobile
terminating (MT) communication handling, high latency communication as described in clause 5.31.8 of
TS 23.501 [2] is applied.
This procedure may be triggered by MT data, or a N1 procedure from SMF and UPF as shown in Figure
4.8.2.2b-1. When the procedure is triggered by other NFs (e.g. SMSF, LMF, GMLC), the UPF (or SMF) in
the following figure should be replaced by the respective NF (the corresponding service operations used by
other NFs when they communicate with AMF may also be different from the service operations used by
SMF/UPF).
During the procedure, the NG-RAN (i.e. gNB) performs RAN paging towards the UE based on the N2
message from the AMF in order to trigger the UE triggered Connection Resume procedure in clause 4.8.2.2.

### SUMMARY

As part of developing embodiments herein one or more problems have been identified. RAN2 has sent a Liaison Statement (LS) to RAN3 and SA2 in R2-2302082 informing that in Rel-18, RAN2 intends to allow configuring extended discontinuous reception (eDRX) beyond 10.24 sec in RRC_INACTIVE together with SDT features, including MO and/or MT versions of SDT.

Currently, as of Rel-18, the 5GCN is not aware of the SDT procedure in NG-RAN.

In case the CN based MT communication handling for UE in RRC_INACTIVE with eDRX>10.24s is applied for downlink signalling/data handling, e.g., MT data is buffered in CN after a request from NG-RAN, when the UE sends a RRC Resume Request to the NG-RAN to send some UL SDT data or UL SDT signalling, the UE will be kept by the NG-RAN in RRC_INACTIVE state. However, the 5GCN cannot be aware of UE's presence during the SDT session and hence cannot deliver any pending DL data to this UE even though from RRC perspective the UE is in RRC_CONNECTED state.

An object of embodiments herein is to improve performance of a UE in a communication network.

According to an aspect the object is achieved, according to some embodiments herein, by providing a method performed by a network node, such as an AMF, for handling communication of a UE in a communication network. The network node receives from a radio network node, a message with an indication indicating that the UE has accessed the communication network for handling one or more SDTs.

According to another aspect the object is achieved, according to some embodiments herein, by providing a method performed by a radio network node, such as an gNB, for handling communication of a UE in a communication network. The radio network node transmits to a network node, a message with an indication indicating that the UE has accessed the communication network for handling one or more SDTs. The radio network node may receive a data indication from the network node indicating pending data for the UE and may decide state of the UE based on the data indication.

It is furthermore provided herein a computer program product comprising instructions, which, when executed on at least one processor, cause the at least one processor to carry out the methods herein, as performed by the radio network node and the network node, respectively. It is additionally provided herein a computer-readable storage medium, having stored thereon a computer program product comprising instructions which, when executed on at least one processor, cause the at least one processor to carry out the methods herein, as performed by the radio network node and the network node, respectively.

Furthermore, according to another aspect the object is achieved, according to some embodiments herein, by providing a network node and a radio network node configured to perform the methods herein, respectively.

Thus, according to an aspect the object is achieved, according to some embodiments herein, by providing a network node, such as an AMF, for handling communication of a UE in a communication network. The network node is configured to receive from a radio network node, a message with an indication indicating that the UE has accessed the communication network for handling one or more SDTs.

According to another aspect the object is achieved, according to some embodiments herein, by providing a radio network node, such as an gNB, for handling communication of a UE in a communication network. The radio network node is configured to transmit to a network node, a message with an indication indicating that the UE has accessed the communication network for handling one or more SDTs.

It is proposed herein to provide means for the network node, such as 5GCN, to be aware of SDT operation in RAN and may be notified of UE availability for the purpose of UL SDT, so that it can transmit buffered DL data and/or signalling, if any.

Embodiments also allow or enable the radio network node to make a quick decision on whether to move the UE to connected state to receive the buffered DL data and/or signalling, or to release UE to Inactive state for SDT transmission based on assistance information coming from the 5GCN.

By notifying the network node, i.e., the 5GCN, of UE has accessed the communication network for handling one or more SDTs, e.g., UE is resuming for MO-SDT purpose, the network node may send any pending DL data, if any, to the radio network node and may alleviate on the amount of data being buffered. The radio network node such as a NG-RAN may then take the decision of moving the UE to RRC_CONNECTED state and may abort the SDT procedure.

Also, as response to RAN N2 notification, the network node such as an AMF, may indicate over N2 as response if there is any assistance information such as pending DL data, to aid the radio network node in making a quick decision and switch the UE to a suitable RRC state.

This will thus result in an improved performance at the UE in the communication network.

### BRIEF DESCRIPTION OF THE DRAWINGS

Embodiments will now be described in more detail in relation to the enclosed drawings, in which:

FIG. 1 shows a Connection Resume in RRC Inactive;

FIG. 2 shows Network Triggered Connection Resume for UE in RRC Inactive with CN based MT communication handling;

FIG. 3 shows an overview depicting a communication network according to embodiments herein;

FIG. 4 is a combined flowchart and signalling scheme according to some embodiments herein;

FIG. 5 shows a flowchart illustrating a method performed by a network node according to embodiments herein;

FIG. 6 shows a flowchart illustrating a method performed by a radio network node according to embodiments herein;

FIG. 7a shows a combined flowchart and signalling scheme according to embodiments herein;

FIG. 7b shows a combined flowchart and signalling scheme according to embodiments herein;

FIG. 8a shows a block diagram depicting embodiments of a network node according to embodiments herein;

FIG. 8b shows a block diagram depicting embodiments of a radio network node according to embodiments herein;

FIG. 9 schematically illustrates a telecommunication network connected via an intermediate network to a host computer;

FIG. 10 is a generalized block diagram of a host computer communicating via a base station with a user equipment over a partially wireless connection; and

FIGS. 11, 12, 13, and 14 are flowcharts illustrating methods implemented in a communication system including a host computer, a base station and a user equipment.

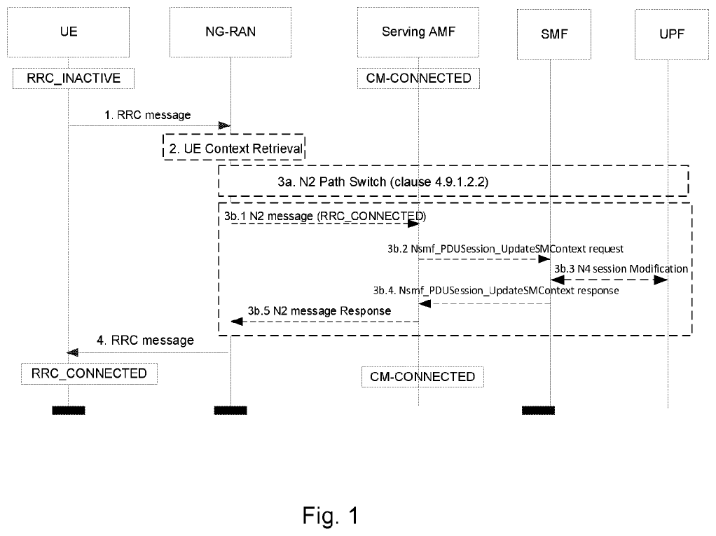

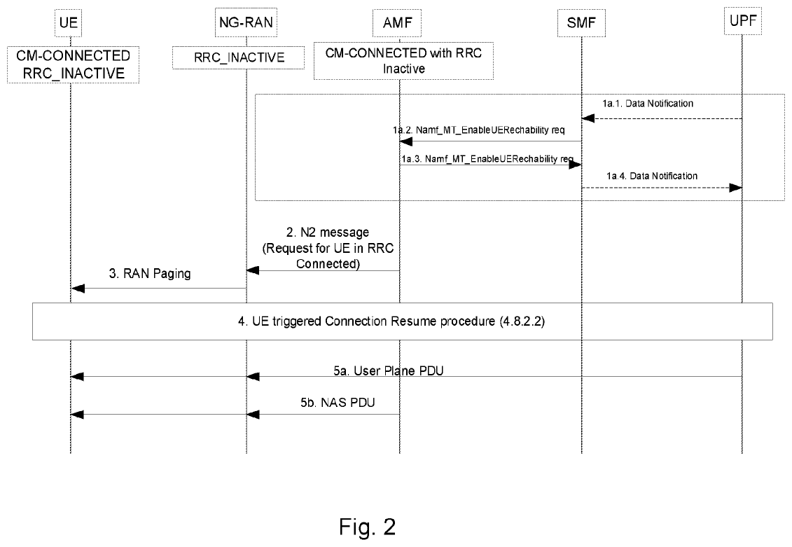

### DETAILED DESCRIPTION

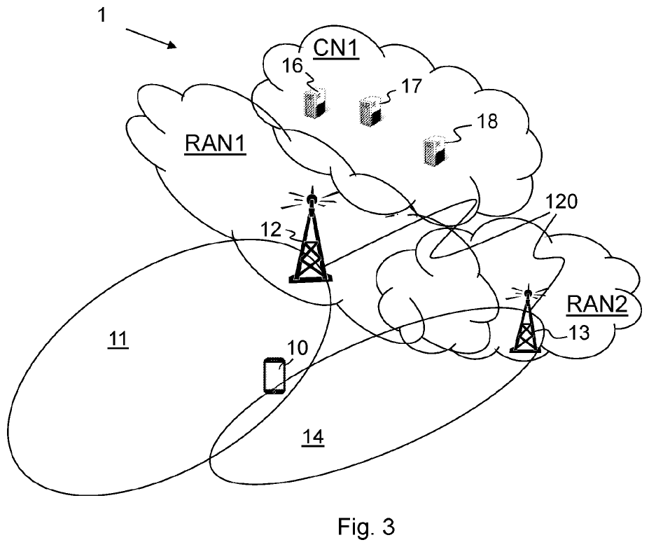

Embodiments herein relate to communication networks in general. FIG. 3 is a schematic overview depicting a communication network 1. The communication network 1 comprises one or more RANs and one or more CNs. The communication network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the communication network 1, a user equipment (UE) 10 exemplified herein as a wireless device such as a mobile station, a non-access point (non-AP) station (STA), a STA and/or a wireless terminal, is comprised communicating via e.g. one or more Access Networks (AN), e.g. radio access network (RAN), to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The communication network 1 comprises a first radio network node 12 or just radio network node, providing radio coverage over a geographical area, a first service area 11 or first cell, of a first radio access technology (RAT), such as NR, LTE, or similar. The radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a UE within the area served by the first radio network node depending e.g. on the first radio access technology and terminology used. The first radio network node may be referred to as a serving radio network node wherein the service area may be referred to as a serving cell, and the serving network node communicates with the wireless device in form of DL transmissions to the wireless device and UL transmissions from the wireless device. It should be noted that a service area may be denoted as cell, beam, beam group or similar to define an area of radio coverage.

The communication network 1 comprises a second radio network node 13 or just radio network node, providing radio coverage over a geographical area, a second service area 14 or second cell, of a second radio access technology (RAT), such as NR, LTE, or similar. The second radio network node 13 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the second radio network node depending e.g. on the first radio access technology and terminology used. The second radio network node may be referred to as a visiting radio network node or target radio network node, wherein the service area may be referred to as a visiting cell or target cell, and the second radio network node communicates with the UE in form of DL transmissions to the UE and UL transmissions from the UE. It should be noted that a service area may be denoted as cell, beam, beam group or similar to define an area of radio coverage.

The first RAT may be the same RAT as the second RAT or the first RAT may be a different RAT than the second RAT.

The communication network 1 may further comprise a number of core network nodes providing, e.g. in NR, network functions (NF) or actually instantiations of NFs also referred to as NF instances, such as a first network node 16, also referred to as network node 16, providing, for example, an instantiation of an AMF or an SMF, a second network node 17 providing an instantiation of a UPF or SMF, and a third network node 18 providing, for example, an instantiation of an PCF; or any other NF instances in the communication network 1. The different NF instances may have different tasks. Other functions may be for LTE such as mobility management entity (MME) or similar.

The respective node may be a standalone server, a cloud-implemented server, a distributed server or processing resources in a server farm or same node. Embodiments herein may be implemented as physical bare metal, virtual or cloud native such as Kubernetes environment in, e.g., hyper-cloud networks.

According to embodiments herein a radio network node 120 such as the first radio network node 12 or the second radio network node 13, transmits to the network node 16, a message with an indication indicating that the UE has accessed the communication network for handling one or more SDTs (also referred to as SDT transmissions). Embodiments may herein propose to add the indication in the message such as a NG application protocol (AP) signalling to notify the 5GCN that the UE 10 has established a connection for SDT and it is reachable, e.g., as if it is in RRC_CONNECTED state.

The indication may be transmitted during one or more of the following:
1) The N2 message from next generation (NG)-RAN to 5GCN adding the indication of SDT during UE Triggered Connection Resume in RRC Inactive procedure;
2) During the NG-AP Path Switch procedure in case of SDT with anchor relocation;
3) In any new N2 procedure where the 5GCN is notified by the radio network node 120 that the UE RRC state is RRC_CONNECTED from RRC perspective, and that the UE 10 may resume to the network for the purpose of SDT;
4) Sending a new resume cause to 5GCN MO-SDT.

Embodiments herein may also add an indication, i.e., a data indication, from 5GCN to RAN to indicate to the radio network node 120 if there is any pending data in the CN for this particular UE 10, and the amount of data. Based on this information the radio network node 120 may decide to either release to UE to RRC_IDLE/RRC_INACTIVE state after SDT in the UL, in case of no pending data, or to move the UE to RRC_CONNECTED state if DL data/signalling is to be delivered. The data indication from 5GCN to RAN may be comprised in the N2 message, as response to RAN notification to CN about UE transition to RRC_CONNECTED state mentioned above for the purpose of SDT, by sending a pending DL data indication to RAN that could be used to aid or help RAN making a quick decision if the UE 10 can be released to RRC_INACTIVE, i.e., RAN can decide to maintain the SDT session.

Yet another proposal is to capture in the specifications that when a UE, such as the UE 10, is paged for MT-SDT, it shall not trigger MO-SDT as a response if the UE is in RRC_INACTIVE configured with an eDRX cycle longer than 10.24 sec. The UE 10 may establish a connection with no SDTs using RRC messages such as RRCSetupRequest or RRCResumeRequest.

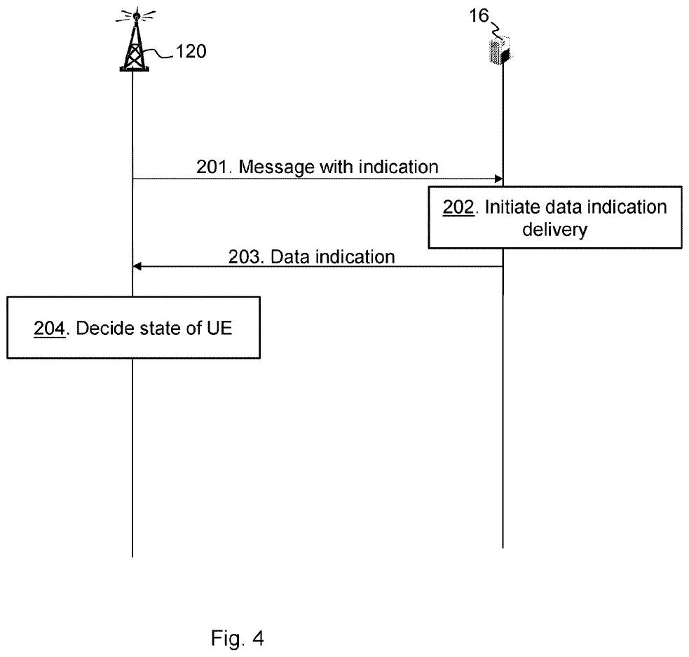

FIG. 4 is a combined flow chart and signalling scheme according to some embodiments herein.

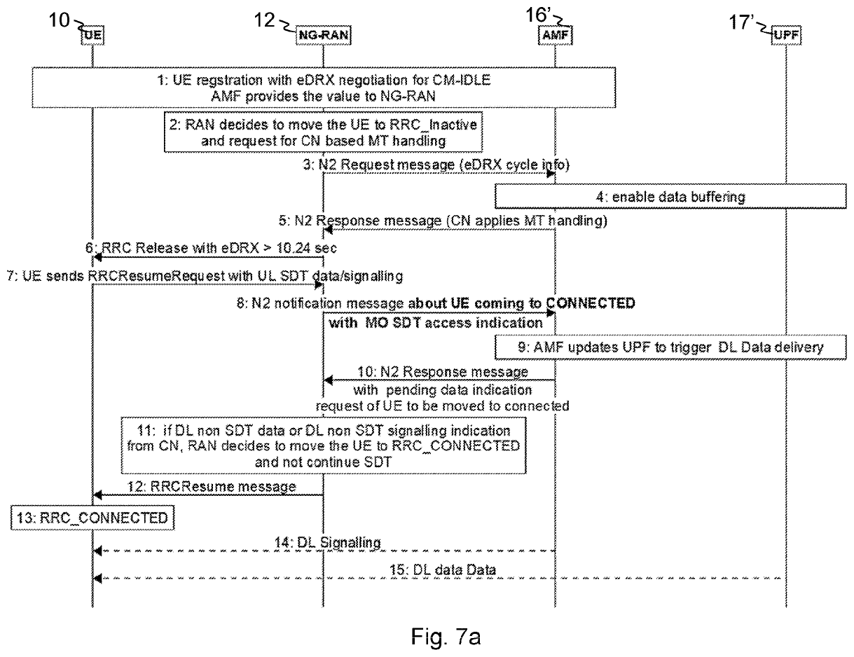

Action 201. The radio network node 120, such as the first radio network node 12 or the second radio network node 13, transmits to the network node 16 the message with the indication indicating that the UE 10 has accessed the communication network 1 for handling one or more SDTs, also referred to as SDT transmissions. This may be indicated during a N2 message for UE Triggered Connection Resume in RRC Inactive procedure with an indication of SDT. In case of UE context retrieval as described in TS 38.300 v.17.0.0 is performed, it may be the target radio network node such as the second radio network node 13 that sends a N2 request to the network node 16 with the indication such as a MO-SDT UE access indication, see action 10 in FIG. 7b.

Action 202. The network node 16 may initiate a data delivery to the UE 10, triggered by the received message. For example, the network node 16 such as an AMF, may notify the UPF of UE's presence for SDT, which triggers DL data signalling. The UPF may transmit buffered data to the UE 10, or the AMF may transmit signalling to the UE 10.

Action 203. For example, the network node 16 may transmit a data indication indicating to the radio network node 120 whether the UE 10 has subsequent DL data or DL signalling. The network node 16 may provide some extra information, such as the data indication, e.g., pending data indication, in a N2 Response to aid the radio network node 120 to make a decision whether the UE 10 can be released (quickly). The network node 16 may send a time indication indicating a time of a timer for which the radio network node 120 should keep the UE in RRC connected state to receive downlink data or signalling. The network node 16 may formulate the extra information and/or the time indication of the timer based on received DL signaling or based on buffered data indication provided by SMF/UPF, see action 11 as described in FIG. 7b. Additionally or alternatively, the network node 16 may indicate to the radio network node 120 whether the UE 10 has subsequent DL data or DL signalling, e.g. one shot, or multiple shots. The network node 16 may reply with a reply indication indicating pending data or timer value to the second network node 13, which second network node 13 may take decision of Continuing the SDT session or not.

Action 203. The radio network node 120 may, upon receiving the buffered data from the UPF, or the signalling from AMF, decide a state of the UE 10. For example, the radio network node 120 may decide to send the UE to RRC_CONNECTED state by sending the RRCResume message and terminate the SDT session, see action 11 in FIG. 7a. The radio network node 120 may receive extra information from the network node 16 and decide the state of the UE 10 based on the extra information. If there is no such extra information, the radio network node 120 may wait for one or more DL packets, to count and to decide if the UE 10 can be released.

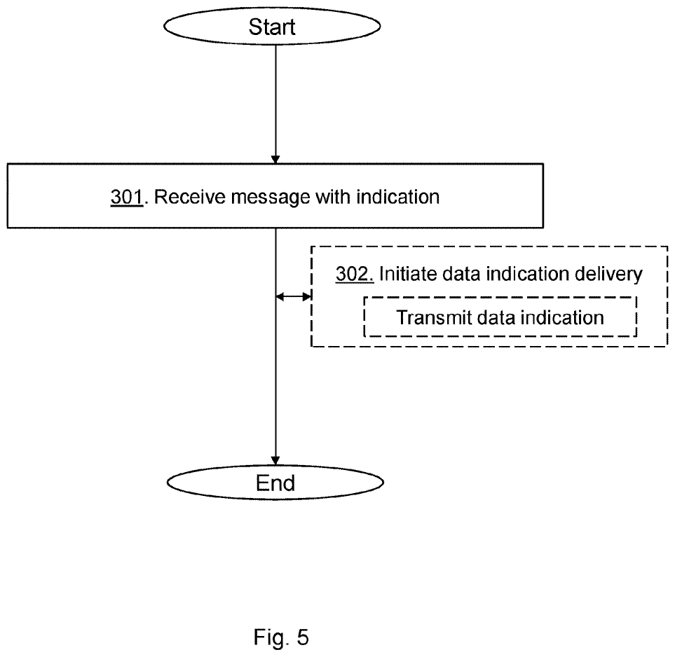

The method actions performed by the network node 16, such as the AMF or the UPF, for handling communication of the UE 10 in the communication network, for example, handling a session, according to embodiments herein will now be described with reference to a flowchart depicted in FIG. 5 The actions do not have to be taken in the order stated below, but may be taken in any suitable order. Actions performed in some embodiments are marked with dashed boxes.

Action 301. The network node 16 receives from the radio network node 120 the message with the indication indicating that the UE 10 has accessed the communication network for handling one or more SDTs. This may be indicated during a N2 message for UE Triggered Connection Resume in RRC Inactive procedure with the indication of SDT such as a MO-SDT UE access indication. The indication may further indicate that the UE 10 is reachable. In case of UE context retrieval as described in TS 38.300 v.17.0.0 is performed, it is the target radio network node such as the second radio network node 13 that sends the N2 request to the network node 13 with the indication such as a MO-SDT UE access indication (FIG. 7b action 10).

Action 302. The network node 16 may initiate the data delivery to the UE 10, triggered by the received message. For example, the network node 16 may notify another network node of UE's presence for SDT, which triggers DL data signalling. The other network node may transmit buffered data to the UE 10, or the network node 16 may transmit DL signalling to the UE 10. The network node may provide extra information, e.g., a pending data indication, in the N2 Response to aid the radio network node 120 to make a decision whether the UE 10 can be released, e.g., quickly. The network node 16 may send the time indication indicating the time value of the timer for which the radio network node 120 should keep the UE in RRC connected state to receive downlink data or signalling. The extra information and/or the time indication of the timer may be based on received DL signaling or based on buffered data indication provided by another network node such as a SMF/UPF in action 11 as described in FIG. 7b. The network node 16 may formulate the extra information and/or the time indication of the timer based on received DL signaling or based on buffered data indication provided by the other network node. Additionally or alternatively, the network node 16 may transmit the data indication indicating to the radio network node 120 whether the UE 10 has subsequent DL data or DL signalling, e.g. one shot, multiple shots. The network node 16 may reply to the received message with a reply indication indicating pending data, extra information, or timer value to the second network node 13, which second network node 13 may take the decision of Continuing the SDT session or not.

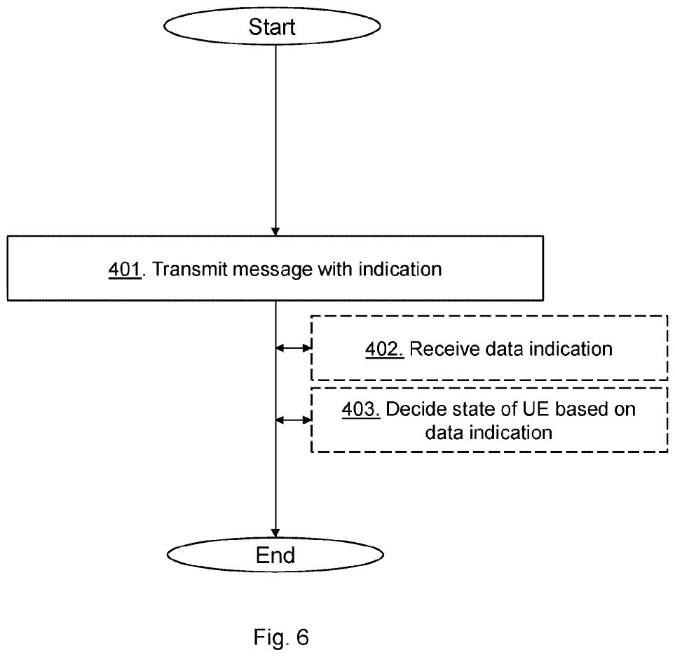

The method actions performed by the radio network node 120, such as the first or the second radio network node 13, for handling communication of the UE 10 in the communication network 1, for example, handling a session, according to embodiments herein will now be described with reference to a flowchart depicted in FIG. 6. The actions do not have to be taken in the order stated below, but may be taken in any suitable order. Actions performed in some embodiments are marked with dashed boxes.

Action 401. The radio network node 120 transmits to the network node 16 the message with the indication indicating that the UE 10 has accessed the communication network for handling one or more SDTs. The indication may further indicate that the UE 10 is reachable. The radio network node 120 may transmit the indication during a N2 message for UE Triggered Connection Resume in RRC Inactive procedure with the indication of SDT. In case of UE context retrieval as described in TS 38.300 v.17.0.0 is performed, it is the target radio network node such as the second radio network node 13 that sends a N2 request to the network node 16 with the indication such as a MO-SDT UE access indication (FIG. 7b action 10).

Action 402. The radio network node may receive a data indication indicating to the radio network node 120 whether the UE 10 has subsequent DL data or DL signalling.

Action 403. The radio network node may, upon receiving the data indication of the buffered data from the other network node such as a UPF, or the signalling from the network node 16 such as the AMF, decide the state of the UE 10. For example, the radio network node 120 may decide the state of the UE 10 by deciding to send the UE to RRC_CONNECTED state by sending the RRCResume message and terminate the SDT session, see action 11 in FIG. 7a. The radio network node 120 may receive the data indication by receiving the extra information from the network node 16 and may decide the state of the UE 10 based on the extra information. If there is no such extra information, the radio network node may wait for one or more DL packets, to count and to decide if UE 10 can be released.

When the UE 10 is paged for MT-SDT, the radio network node 120 may not trigger a MO-SDT as a response if the UE 10 is in RRC_INACTIVE configured with an eDRX cycle longer than 10.24 sec. The UE 10 may establish a connection with no small data transmission (SDT) using RRC messages such as RRCSetupRequest or RRCResumeRequest.

In some embodiments herein the radio network node 120 such as NG-RAN indicates to 5GCN that the UE 10 has accessed the network for MO-SDT transaction.

This may be indicated during the N2 message for UE Triggered Connection Resume in RRC Inactive procedure with the indication of SDT.

The network node 16 such as AMF may notify another network node such as the UPF of UE's presence for SDT, which triggers DL data signalling. The radio network node 120 upon receiving the buffered data from the UPF, or signalling from AMF, may decide to send the UE 10 to RRC_CONNECTED state by sending the RRCResume message and terminate the SDT session as described in FIG. 7a action 11.

The network node 16, such as 5GCN, may provide some extra information, e.g., pending data indication, in the N2 Response to help the radio network node 120 to make a quick decision whether the UE 10 can be released quickly. If there is no such extra information, then the radio network node 120 may need to wait for the DL packets, to count and to decide if the UE 10 can be released. The network node 16, such as the AMF, may formulate the extra information based on received DL signaling or based buffered data indication provided by SMF/UPF, see actions 11,12 as described in FIG. 7b.

The network node 16 indicates a timer for which the radio network node 120, such as a gNB, may keep the UE 10 in RRC connected state to receive downlink data or signalling. The network node may formulate the timer information based on received DL signaling or based on buffered data indication provided by SMF/UPF.

The network node 16 may indicate to the radio network node 120 whether the UE has subsequent DL data or DL signalling, e.g., one shot, multiple shots.

In case of UE context retrieval as described in TS 38.300 v.17.0.0, in one embodiment, it is the new gNB, such as the second network node 13, that sends the N2 request to CN with the MO-SDT UE access indication, asse action 10 in FIG. 7b. The network node 16 may reply with the data indication of pending data or timer to the new gNB, such as the second network node 13, which would take decision of Continuing the SDT session or not.

Embodiments herein may be captured in the specifications and state that when a UE is paged for MT-SDT, it shall not trigger MO-SDT as a response if the UE 10 is in RRC_INACTIVE configured with an eDRX cycle longer than 10.24 sec. The UE 10 may establish a connection with no SDTs using RRC messages such as RRCSetupRequest or RRCResumeRequest.

FIG. 7a is a combined flowchart and signalling scheme according to some embodiments herein and shows notification of the UE 10 being moved to RRC_CONNECTED state with MO-SDT. The NG-RAN is an example of the radio network node 120, and AMF is an example of the network node 16.
Action 1. UE registration with eDRX negotiation for CM-IDLE. AMF provides the value to NG-RAN.
Action 2. RAN, i.e., NG-RAN, decides to move the UE 10 to RRC_inactive and request for CN based MT handling.
Action 3. The NG-RAN sends N2 request message with eDRX cycle information.
Action 4. AMF and UPF enable data buffering.
Action 5. The AMF sends a N2 response message (CN applies MT handling).
Action 6. The NG-RAN indicates a RRC release with eDRX>10.24 seconds.
Action 7. The UE 10 sends a RRCresumerequest with UL SDT data/signalling.
Action 8. According to embodiments herein, the NG-RAN sends N2 notification message indicating about UE coming to connected state with the indication such as a MO-SDT access indication. This is an example of action 401 in FIG. 6.
Action 9. The AMF updates the UPF to trigger data delivery. This is an example of action 302 in FIG. 5.
Action 10. The AMF transmits a N2 response message with data indication or pending data indication requesting UE to move to connected state. This is an example of action 302 in FIG. 5.
Action 11. The NG-RAN decides, if DL non SDT data or DL non SDT signalling indication from the network node (or CN), to move the UE to RRC_Connected state and not continue SDT. This is an example of action 403 in FIG. 6.
Action 12. The NG-RAN transmits a RRCResume message to the UE 10.
Action 13. The UE 10 moves to connected state or RRC_Connected.
Action 14. The AMF may transmit DL signalling to the UE 10.
Action 15. The UPF may transmit DL data to the UE 10.

FIG. 7b is a combined flowchart and signalling scheme according to some embodiments herein an shows notification of UE moved to RRC_CONNECTED state with MO-SDT in case of UE context retrieval when UE resumes in a new gNB such as the second radio network node 13. Thus, the network node 16 is exxmeplfied as an AMF and the radio network node 120 is exemplified as gNB.
Action 1. UE registration with eDRX negotiation for CM-IDLE. AMF provides the value to NG-RAN.
Action 2. The first radio network node 12 decides to move the UE to RRC inactive and request for CN based MT handling.
Action 3. The first radio network node 12 sends N2 request message with eDRX cycle information.
Action 4. AMF and UPF enable data buffering.
Action 5. The AMF sends a N2 response message (CN applies MT handling).
Action 6. The first radio network node 12 indicates a RRC release with eDRX>10.24 seconds.
Action 7. The UE sends to the second radio network node 13, a RRCresumerequest with UL SDT data/signalling.
Action 8. The second radio network node 13 sends a retrieve UE context request to the first radio network node 12 with an SDT indicator.
Action 9. The first radio network node 12 sends a retrieve UE context response to the second radio network node 13.
Action 10. According to embodiments herein, the second radio network node 13 sends N2 notification message indicating about UE coming to connected state with the indication such as a MO-SDT access indication. This is an example of action 401 in FIG. 6.
Action 11. The AMF updates the UPF to trigger data delivery. This is an example of action 302 in FIG. 5.
Action 12. The AMF transmits a N2 response message with data indication or pending data indication requesting UE to move to connected state. This is an example of action 302 in FIG. 5.
Action 13. Option 1: DL data/Signalling is available
Action 14. The second radio network node 13 decides to move the UE to RRC_Connected state. This is an example of action 403 in FIG. 6.
Action 15. The AMF may transmit DL signalling to the UE.
Action 16. The UPF may transmit DL data to the UE.
Action 17. Option 2: no DL data/signalling is available
Action 18. The MO-SDT procedures as defined in TS 38.300 section 18.2 is performed.
Action 19. The UE is in RRC_Inactive state.

Below are the potential standard impact, underlined and bold, to NGAP TS 38.413 v17.3.0

### 9.2.4.X1 Rrc State Transition Indication

This message is sent by the NG-RAN to indicate the RRC state of the UE (indication in action 401)

Direction: NG-RAN node→AMF

| | | | IE type and | Semantics |
|---|---|---|---|---|
| IE/Group Name | Presence | Range | reference | description |
| Message Type | M | | 9.3.1.1 | |
| AMF UE NGAP ID | M | | 9.3.3.1 | |
| RAN UE NGAP ID | M | | 9.3.3.2 | |
| RRC state | O | | INTEGER | |
| | | | (connected, | |
| | | | inactive, . . . | |
| Resume cause | O | | ENUMERATED(MO- | |
| | | | SDT, . . . ) | |

### 9.2.4.X1 RRC State Transition Response

This message is sent by the AMF to indicate information about UE pending data (data indication in action 302)

Direction: AMF→NG-RAN node

| | | | IE type and | Semantics |
|---|---|---|---|---|
| IE/Group Name | Presence | Range | reference | description |
| Message Type | M | | 9.3.1.1 | |
| AMF UE NGAP ID | M | | 9.3.3.1 | |
| RAN UE NGAP ID | M | | 9.3.3.2 | |
| Pending downlink | O | | INTEGER | |
| data | | | (true, one- | |
| | | | shot, | |
| | | | multiple- | |
| | | | shot, . . . ) | |
| Extended | O | | 9.3.3.31 | If present, the |
| Connected Time | | | | UE should be |
| | | | | moved to |
| | | | | RRC CONNECTED |
| | | | | state for |
| | | | | the indicated |
| | | | | time |

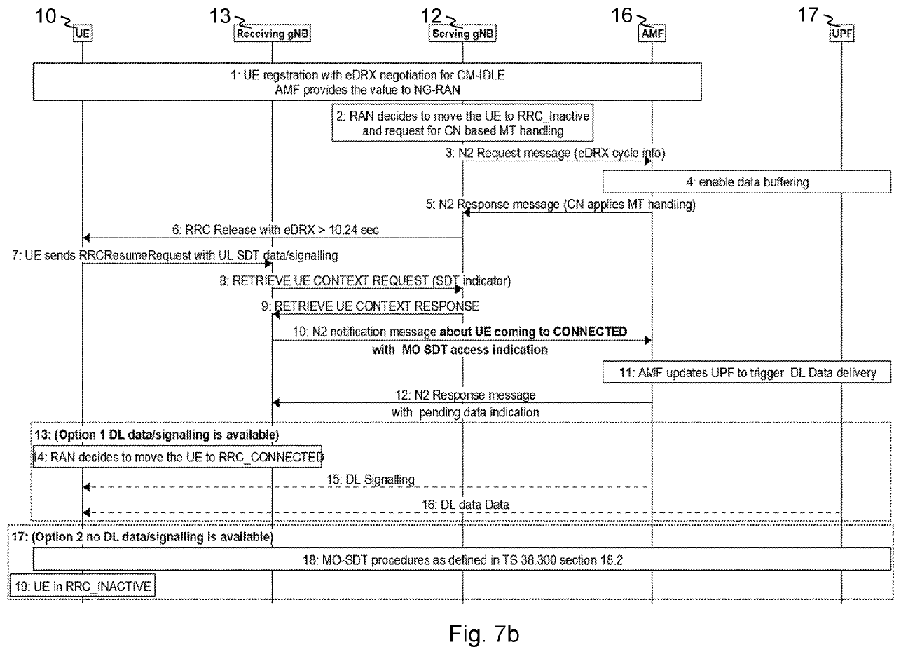

FIG. 8a is a block diagram depicting the network node 16, such as the AMF or SMF, for handling communication of the UE 10 in the communication network 1 according to embodiments herein.

The network node 16 may comprise processing circuitry 701, e.g. one or more processors, configured to perform the methods herein.

The network node 16 and/or the processing circuitry 701 is configured to receive from the radio network node the message with the indication indicating that the UE has accessed the communication network for handling one or more SDTs. This may be indicated during a N2 message for UE Triggered Connection Resume in RRC Inactive procedure with the indication of SDT such as a MO-SDT UE access indication. The indication may further indicate that the UE 10 is reachable. In case of UE context retrieval as described in TS 38.300 v.17.0.0 is performed, it is the target radio network node such as the second radio network node 13 that sends the N2 request to the network node with the indication such as a MO-SDT UE access indication (FIG. 7b action 10).

The network node 16 and/or the processing circuitry 701 may be configured to initiate the data delivery to the UE, triggered by the received message. For example, the network node 16 and/or the processing circuitry 701 may be configured to notify another network node of UE's presence for SDT, which triggers DL data signalling. The other network node may be configured to transmit buffered data to the UE, or the network node 16 and/or the processing circuitry 701 may be configured to transmit signalling to the UE 10. The network node 16 and/or the processing circuitry 701 may be configured to provide the extra information, e.g., a pending data indication, in the N2 Response to help the radio network node to make a decision on if the UE 10 can be released quickly. The network node 16 and/or the processing circuitry 701 may be configured to send the time indication indicating the time value of the timer for which the radio network node should keep the UE in RRC connected state to receive downlink data or signalling. The extra information and/or the time indication of the timer may be based on received DL signaling or based on buffered data indication provided by another network node such as a SMF/UPF in action 11 as described in FIG. 7b. The network node 16 and/or the processing circuitry 701 may be configured to formulate the extra information and/or the time indication of the timer based on received DL signaling or based on buffered data indication provided by the other network node. Additionally, or alternatively, the network node 16 and/or the processing circuitry 701 may be configured to transmit the data indication indicating to the radio network node 120 whether the UE 10 has subsequent DL data or DL signalling, e.g. one shot, multiple shots. The network node 16 and/or the processing circuitry 701 may be configured to reply to the received message with the reply indication indicating pending data, extra information, or timer value to the second network node 13, which second network node 13 may take the decision of Continuing the SDT session or not.

The network node 16 may comprise a memory 705. The memory 705 comprises one or more units to be used to store data on, such as data packets, indications, messages, support information, events and applications to perform the methods disclosed herein when being executed, and similar. Furthermore, the network node 16 may comprise a communication interface 706 such as comprising a transmitter, a receiver, a transceiver and/or one or more antennas.

The methods according to the embodiments described herein for the network node 16 are respectively implemented by means of e.g. a computer program product 707 or a computer program, comprising instructions, i.e., software code portions, which, when executed on at least one processor, cause the at least one processor to carry out the actions described herein, as performed by the network node 16. The computer program product 707 may be stored on a computer-readable storage medium 708, e.g., a disc, a universal serial bus (USB) stick or similar. The computer-readable storage medium 708, having stored thereon the computer program product, may comprise the instructions which, when executed on at least one processor, cause the at least one processor to carry out the actions described herein, as performed by the network node 16. In some embodiments, the computer-readable storage medium may be a transitory or a non-transitory computer-readable storage medium. Thus, embodiments herein may disclose the network node for handling communication of the UE in a communication network, wherein the network node comprises processing circuitry and a memory, said memory comprising instructions executable by said processing circuitry whereby said network node is operative to perform any of the methods herein.

FIG. 8b is a block diagram depicting the radio network node 120, such as a first radio network node 12 or the second radio network node 13, for handling communication of the UE 10 in the communication network 1 according to embodiments herein.

The radio network node 120 may comprise processing circuitry 801, e.g. one or more processors, configured to perform the methods herein.

The radio network node 120 and/or the processing circuitry 801 is configured to transmit to the network node 16 the message with the indication indicating that the UE 10 has accessed the communication network for handling one or more SDTs. The radio network node 120 and/or the processing circuitry 801 may be configured to transmit the indication during a N2 message for UE Triggered Connection Resume in RRC Inactive procedure with the indication of SDT such as a MO-SDT UE access indication. The indication may further indicate that the UE 10 is reachable. In case of UE context retrieval as described in TS 38.300 v.17.0.0 is performed, it is the target radio network node such as the second radio network node 13 that sends a N2 request to the network node with the indication such as a MO-SDT UE access indication (FIG. 7b action 10).

The radio network node 120 and/or the processing circuitry 801 may be configured to receive the data indication indicating to the radio network node 120 whether the UE 10 has subsequent DL data or DL signalling.

The radio network node 120 and/or the processing circuitry 801 may be configured to, upon receiving the data indication of the buffered data from the other network node, or the signalling from the network node 16, decide or determine the state of the UE 10. For example, the radio network node 120 and/or the processing circuitry 801 may be configured to decide to send the UE to RRC_CONNECTED state by sending the RRCResume message and terminate the SDT session, see action 11 in FIG. 7a. The radio network node 120 and/or the processing circuitry 801 may be configured to receive the extra information from the network node 16 and may decide the state of the UE based on the extra information. If there is no such extra information, the radio network node 120 and/or the processing circuitry 801 may be configured to wait for one or more DL packets, to count and to decide if the UE 10 can be released.

When the UE 10 is paged for MT-SDT, the radio network node 120 and/or the processing circuitry 801 may be configured to not trigger MO-SDT as a response if the UE 10 is in RRC_INACTIVE configured with an eDRX cycle longer than 10.24 sec. The UE 10 may establish a connection with no SDTs using RRC messages such as RRCSetupRequest or RRCResumeRequest.

The radio network node 120 may comprise a memory 805. The memory 805 comprises one or more units to be used to store data on, such as data packets, indications, messages, data indication, reply indication, further indications, information, events and applications to perform the methods disclosed herein when being executed, and similar. Furthermore, the radio network node 120 may comprise a communication interface 806 such as comprising a transmitter, a receiver, a transceiver and/or one or more antennas.

The methods according to the embodiments described herein for the radio network node 120 are respectively implemented by means of e.g. a computer program product 807 or a computer program, comprising instructions, i.e., software code portions, which, when executed on at least one processor, cause the at least one processor to carry out the actions described herein, as performed by the radio network node 120. The computer program product 807 may be stored on a computer-readable storage medium 808, e.g., a disc, a universal serial bus (USB) stick or similar. The computer-readable storage medium 808, having stored thereon the computer program product, may comprise the instructions which, when executed on at least one processor, cause the at least one processor to carry out the actions described herein, as performed by the radio network node 120. In some embodiments, the computer-readable storage medium may be a transitory or a non-transitory computer-readable storage medium. Thus, embodiments herein may disclose the radio network node for handling communication of the UE in a communication network, wherein the radio network node comprises processing circuitry and a memory, said memory comprising instructions executable by said processing circuitry whereby said radio network node is operative to perform any of the methods herein.

In some embodiments a more general term “network node” is used and it can correspond to any type of radio-network node or any network node, which communicates with a UE and/or with another network node.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), IoT capable device, machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. NR, Wi-Fi, LTE, LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

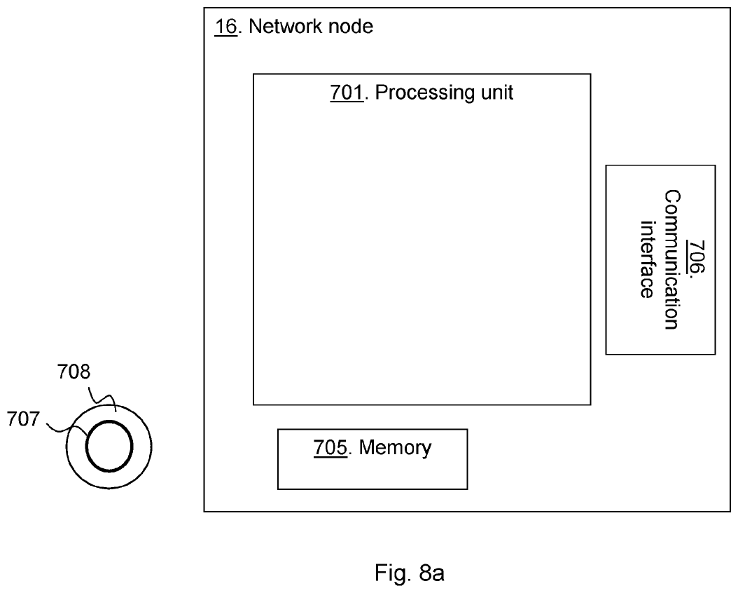

With reference to FIG. 9, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 9 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

In some embodiments, the telecommunication network 3210 includes one or more Open-RAN (ORAN) network nodes. An ORAN network node is a node in the telecommunication network 3210 that supports an ORAN specification (e.g., a specification published by the O-RAN Alliance, or any similar organization) and may operate alone or together with other nodes to implement one or more functionalities of any node in the telecommunication network 3210, including one or more network nodes and/or core network nodes.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes facilitate direct or indirect connection of user equipment (UE), such as by connecting UEs (one or more of which may be generally referred to as UEs 3291, 3292) to the core network over one or more wireless connections.

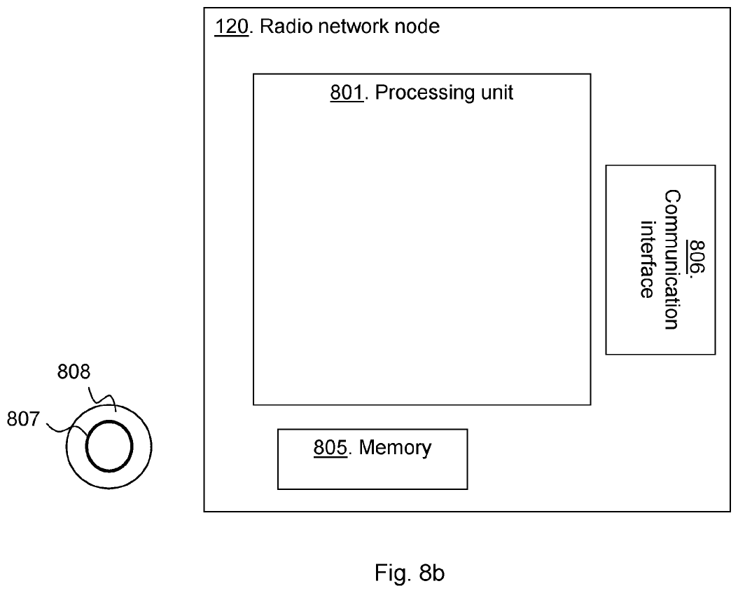

Example implementations, in accordance with an embodiment, of the UE, base station and host computer discussed in the preceding paragraphs will now be described with reference to FIG. 10. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 10) served by the base station 3320. The communication interface 3326 may be configured to facilitate a connection 3360 to the host computer 3310. The connection 3360 may be direct or it may pass through a core network (not shown in FIG. 10) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 10 may be identical to the host computer 3230, one of the base stations 3212a, 3212b, 3212c and one of the UEs 3291, 3292 of FIG. 9, respectively. This is to say, the inner workings of these entities may be as shown in FIG. 10 and independently, the surrounding network topology may be that of FIG. 9.

In FIG. 10, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since SDT may be handled more efficiently and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

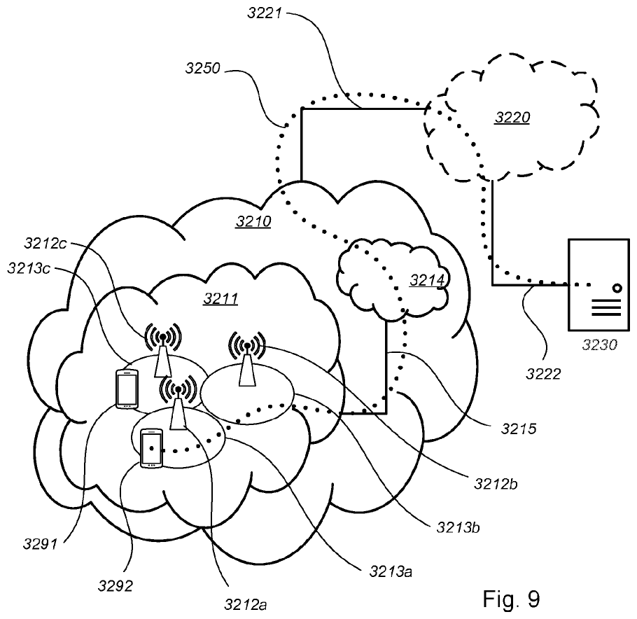

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

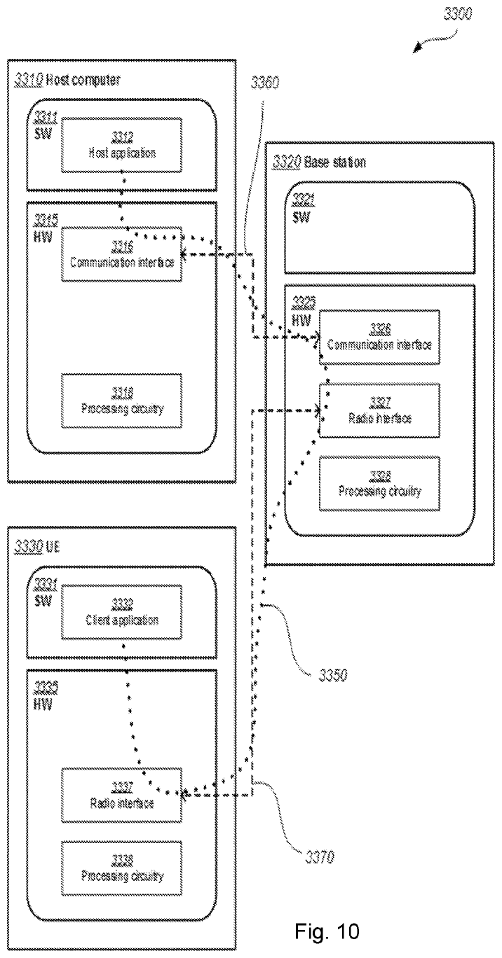

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

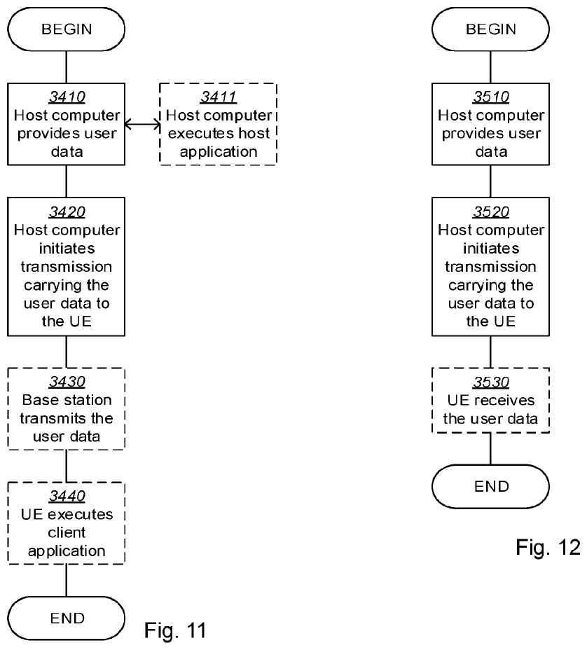

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

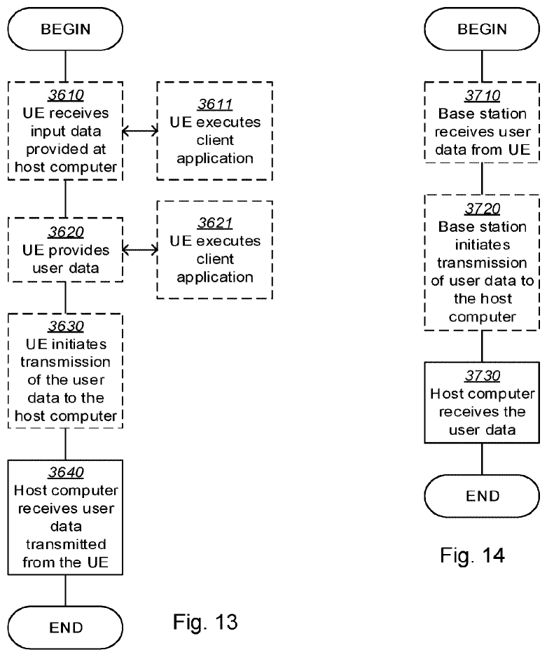

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

| Abbreviation | Explanation |
|---|---|
| 5GC | 5G Core Network |
| AMF | Access and Mobility Management Function |
| NGAP | NG Application Protocol |
| NG-C | NG Control Plane |
| RAN | Radio Access Network |
| RAT | Radio Access Technology |
| SDT | Small Data Transmission |
| UE | User Equipment |

### Embodiments

### Embodiment A1

A method performed by a network node for handling communication of a UE in a communication network, the method comprising
receiving from a radio network node, a message with an indication indicating that the UE has accessed the communication network for handling one or more SDT transmissions.

### Embodiment B1

A method performed by a radio network node for handling communication of a UE in a communication network, the method comprising
transmitting to a network node, a message with an indication indicating that the UE has accessed the communication network for handling one or more SDT transmissions.

### Embodiment C1

A network node for handling communication of a UE in a communication network, wherein the network node is configured to:
receive from a radio network node, a message with an indication indicating that the UE has accessed the communication network for handling one or more SDT transmissions.

### Embodiment D1

A radio network node for handling communication of a UE in a communication network, wherein the radio network node is configured to
transmit to a network node, a message with an indication indicating that the UE has accessed the communication network for handling one or more SDT transmissions.

1-38. (canceled)

39. A method performed by a network node for handling communication of a user equipment (UE) in a communication network, the method comprising
receiving from a radio network node, a message with an indication indicating that the UE has accessed the communication network for handling one or more small data transmissions (SDT).

40. The method according to claim 39, wherein the indication further indicates that the UE is reachable.

41. The method according to claim 39, wherein the message comprises a N2 message for UE Triggered Connection Resume in radio resource control (RRC) Inactive procedure with an indication of SDT.

42. The method according to claim 39, further comprising initiating a data delivery to the UE, triggered by the received message.

43. The method according to claim 42, wherein initiating the data delivery comprises notifying another network node of a presence of the UE for SDT, thereby triggering downlink (DL) data signaling.

44. The method according to claim 42, wherein initiating the data delivery comprises providing extra information in a N2 Response, to aid the radio network node in deciding whether the UE can be released.

45. The method according to claim 42, wherein initiating the data delivery comprises sending a time indication indicating a time value of a timer for which the radio network node should keep the UE in RRC connected state to receive downlink data or signaling.

46. The method according to claim 45, wherein the extra information and/or the time indication of the timer is based on received downlink (DL) signaling or based on a buffered data indication provided by another network node.

47. The method according to claim 42, wherein initiating the data delivery comprises transmitting a data indication indicating to the radio network node whether the UE has subsequent downlink (DL) data or DL signaling.

48. The method according to claim 42, wherein initiating the data delivery comprises replying to the received message with a reply indication indicating pending data, extra information, and/or a timer value to a second radio network node, which second radio network node takes a decision of continuing the SDT session or not.

49. A method performed by a radio network node for handling communication of a user equipment (UE) in a communication network, the method comprising:
transmitting to a network node, a message with an indication indicating that the UE has accessed the communication network for handling one or more small data transmissions (SDT).

50. The method according to claim 49, wherein the indication further indicates that the UE is reachable.

51. The method according to claim 49, wherein the message comprises a N2 message for UE Triggered Connection Resume in a radio resource control (RRC) Inactive procedure with an indication of SDT.

52. The method according to claim 49, further comprising receiving a data indication indicating to the radio network node whether the UE has subsequent downlink (DL) data or DL signaling.

53. The method according to claim 52, further comprising, upon receiving the data indication of buffered data from another network node, or the signaling from the network node, deciding a state of the UE.

54. The method according to claim 53, wherein deciding the state comprises deciding to send the UE to RRC_CONNECTED state by sending a RRCResume message and terminate a SDT session.

55. The method according to claim 52, wherein receiving the data indication comprises receiving extra information from the network node and deciding the state of the UE based on the extra information.

56. The method according to claim 55, wherein, if there is no extra information, the radio network node waits for one or more downlink (DL) packets, to count and to decide whether the UE can be released.

57. A network node for handling communication of a user equipment (UE) in a communication network, wherein the network node comprises:
a communication interface configured for communicatively coupling the network node with a radio network node; and
processing circuitry operatively associated with the communication interface and configured to receive from the radio network node, a message with an indication indicating that the UE has accessed the communication network for handling one or more small data transmissions (SDT).

58. A radio network node for handling communication of a user equipment (UE) in a communication network, wherein the radio network node comprises:
a communication interface configured to communicatively couple the radio network node with a network node; and
processing circuitry operatively associated with the communication interface and configured to transmit to the network node, a message with an indication indicating that the UE has accessed the communication network for handling one or more small data transmissions (SDT).
